(19) United States
(12) Patent Application Publication
(10) Pub. No.: US 2008/0024366 A1
(43) Pub. Date: Jan. 31, 2008

(54) DUAL BAND FLAT ANTENNA

(75) Inventor: Shih-Chieh Cheng, Yongkang City (TW)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Arcadyan Technology Corporation

(21) Appl. No.: 11/459,653

(22) Filed: Jul. 25, 2006

(51) Int. Cl. H01Q 1/38

(52) U.S. Cl. 343/700 MS

(57) ABSTRACT

The present invention provides a dual band and dual mode flat antenna. The antenna structure comprises a substrate; a ground member configured on the substrate; an interdigital shape radiator having a first portion radiator and a second portion radiator configured on the substrate, wherein the second portion radiator being connected to a first end of said first portion radiator; and a feed line connected to the second end of the first portion radiator of the interdigital shape radiator.

### BACKGROUND OF THE INVENTION

1. Field of the Invention

The present invention relates generally to an antenna structure, and more particularly to a dual band and dual mode flat antenna structure with an interdigital shape radiating radiator.

2. Description of the Prior Art

As telecommunication technologies advance from wired to wireless communication driven by efficiency and convenience for the general public in the past decade, wireless communication devices and their implementation have become ubiquitous. Antennas have been a key building block in the construction of every wireless communication system. The antenna is the device that allows RF energy to transmit between wired transmission lines and free space. Consequently, antennas and propagation are the key factors influencing the robustness and quality of the wireless communication channel.

Typically, conventional helical antennas or linear monopole antennas are used as antennas for potable terminals. The helical antennas or linear monopole antennas have a merit of omni-directional radiation characteristic, since they are of external type projecting outside the device, and therefore they are likely to be damaged by an external force.

One important application of dual-band micro-strip antennas is in mobile communication systems. A common configuration for an antenna in such use is the inverted-F geometry which is described in two articles by Zi Dong Liu and Peter S. Hall. The first article is “Dual-band antenna for hand held portable telephones”, Electronics Letters, Vol. 32, No. 7, pp. 609 610 March 1996), and the second article is “Dual-Frequency Planar Inverted-F Antenna”, IEEE Transactions on Antennas and Propagation, Vol. 45, pp. 1451 1457 (October 1997).

Liu and Hall describe two dual-frequency-band antenna configurations, one with a single input port and the other with two input ports. The two-port antenna consists of two co-planar radiating elements—the first one being rectangular and the second one being L-shaped and having two sides adjacent the first one. The rectangular element is for 1.8 GHz signals, while the L-shaped element is for 0.9 GHz signals. This configuration of dual-band antenna is about the same size as a single-band inverted-F antenna for 0.9 GHz signals. Both the rectangular element and the L-shaped element have one end shorted to the ground plane. Because the two radiating elements are not connected, the coupling between the two antennas is small and only due to fringe-field interaction. A variation has a single input port connected to an intermediate point of connection between the rectangular element and the L-shaped element. Although it has the advantage of using only a single input port, this arrangement has the drawback that the coupling between the rectangular element and the L-shaped element is increased.

Since the miniaturization method used in the conventional antenna is based on a two-dimensional structure, for example a dual band planar antenna design of conventional antenna shown in FIG. 1, there is a limit to the miniaturization. Shown as FIG. 1, a conventional dual band antenna has a high band radiating part 10, a low band radiating part 11, a feed pin 12 and a ground plate 13. The feed point 14 is connected to the ground plate 13. For example, the dimension of such antenna is about three centimeter of length and one centimeter of width, and the antenna has a narrower bandwidth owing to standing wave radiation. Moreover, because the space for the antenna in the portable device is reduced day by day, there is a keen need of improvement for the miniaturization. There is still a need of improvement in view of a space disposition or a feeding efficiency for the antenna.

### SUMMARY OF THE INVENTION

In view of the drawbacks of prior art, which less radiation gain and badly disposing elasticity owing to the less available antenna types of the conventional planar antenna, the present invention provides a new design antenna structure with an interdigital shape radiator for providing a suitable use in more than one frequency range.

One object of the present invention is to provide a planar antenna which can improve the disposing elasticity of the antennas owing to extremely few available planar antennas, such as 2.4 GHz, 5.0 GHz planar antenna, types.

Another object of the present invention is to provide an interdigital shape antenna with a good radiating gain which can reduce the interference between space radiating channels and improve the transmission capacity of each one of the channels owing to good performance of the spatial diversity and radiation patterns.

Still another object of the present invention is to provide an antenna structure which interdigital shape radiator has a first portion radiator and a second portion radiator connected to the each other to improve the performance of the antenna.

The present invention provides a dual band and dual mode flat antenna. The antenna structure comprises a substrate; a ground member configured on the substrate; an interdigital shape radiator having a first portion radiator and a second portion radiator configured on the substrate, wherein the second portion radiator being connected to a first end of said first portion radiator; and a feed line connected to the second end of the first portion radiator of the interdigital shape radiator.

The interdigital shape radiator is parallel to the ground member. The interdigital shape radiator is formed on a first surface of the substrate and the ground member is formed on a second surface of the substrate, the first surface being opposite to the second surface. Another embodiment, the interdigital shape radiator is co-planar with the ground member. Such structure, the feeding line is co-planar with the ground member, and a feed point of the feeding line is an end of a coplanar waveguide (CPW) feeding type.

The thickness of the above antenna structure (substrate) is from 0.2 millimeter to 2.0 millimeter. The length of the first portion radiator of the interdigital shape radiator is about from 20 millimeter to 30 millimeter, and the width of the first portion radiator of the interdigital shape radiator is about from 0.2 millimeter to 2.0 millimeter. The pitch of the second portion radiator with interdigital shape is about from 0.4 millimeter to 0.6 millimeter. The length of the second portion radiator of the interdigital shape radiator is about from 8.0 millimeter to 12 millimeter, and the width of the second portion radiator is about from 0.2 millimeter to 2.0 millimeter.

The included angle between the second portion radiator and the first portion radiator is about 20˜80 degree.

The first portion radiator is used to radiate signal by a traveling wave mode and the second portion radiator is used to radiate signal by a standing wave mode.

The aforementioned objects, features, and advantages will become apparent from the following detailed description of a preferred embodiment taken together with the accompanying drawings.

### BRIEF DESCRIPTION OF THE DRAWINGS

A preferred embodiment of the invention will be illustrated further in the following description and accompanying drawings, and wherein:

FIG. 1 is a schematic diagram of the conventional dual mode antenna of the prior art.

FIG. 2 is a schematic diagram of the interdigital shape dual mode antenna according to the present invention.

FIG. 3 is a schematic diagram of the interdigital shape dual mode antenna with a coplanar waveguide (CPW) feeding line according to the present invention.

FIG. 4 is the SWR according to the present invention.

FIG. 5 is the radiation pattern in a resonant frequency of 2.4 GHz according to the present invention.

FIG. 6 is the radiation pattern in a resonant frequency of 2.45 GHz according to the present invention.

FIG. 7 is the radiation pattern in a resonant frequency of 4.9 GHz according to the present invention.

FIG. 8 is the radiation pattern in a resonant frequency of 5.35 GHz according to the present invention.

FIG. 9 is the radiation pattern in a resonant frequency of 5.75 GHz according to the present invention.

FIG. 10 is the radiation pattern in a resonant frequency of 5.85 GHz according to the present invention.

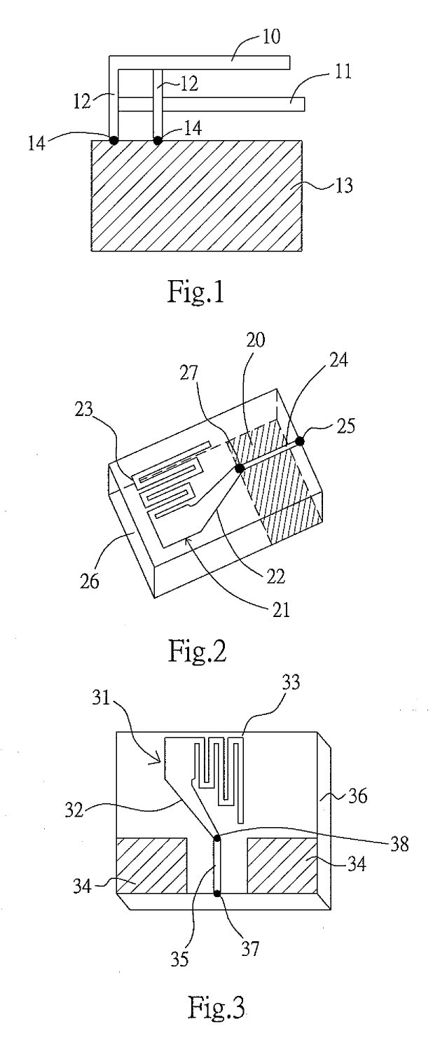

### DESCRIPTION OF THE PREFERRED EMBODIMENT

The preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

The basic properties that are used to describe the performance of an antenna include impedance, voltage standing wave ratio (VSWR) or standing wave ratio (SWR), amplitude radiation patterns, directivity, gain, polarization and bandwidth.

In order to achieve maximum power transfer between a wire or coaxial transmission line and an antenna, the input impedance of the antenna must identically match the characteristic impedance of the transmission line. The ratio between the maximum voltage and the minimum voltage along the transmission line is defined as the VSWR. The VSWR, which can be derived from the level of reflected and forward waves, is also an indication of how closely or efficiently an antenna's terminal input impedance is matched to the characterized impedance of the transmission line. An increase in VSWR indicates an increase in the mismatch between the antenna and the transmission line.

The dual-band micro-strip antenna has, as shown in FIG. 2, a ground plate 20, an interdigital shape radiator 21 having a first portion radiator 22 and a second radiator 23. Such a planar antenna structure is suitable for use in more than one frequency range. A feed line 24 may be an extension of a wire of a coaxial cable (not shown), and connected to an end point position on the first portion radiator 22. The connection point of feed line 24 and the lengths of the first portion radiator 22 and the second portion radiator 23 are experimentally adjusted until the desired antenna bandwidths and a desired impedance match are obtained. FIG. 2 illustrates the orientation of the antenna with respect to an X-Y-Z co-ordinate system that has application to the radiation patterns.

Referring to FIG. 2, it shows a schematic diagram of the interdigital shape dual mode flat antenna of the present invention. The antenna structure comprises a ground plate 20. An interdigital shape radiator 21 having a first portion radiator 22 and a second portion radiator 23 is configured onto a substrate 26 and connected to a feed line 24. An included angle is formed between the first portion radiator 22 and the second portion radiator 23. The angle is preferably about 20˜80 degrees. The feed point 25 can be implemented as a coaxial feed. The feed point can also be implemented by placing it at the edge of the interdigital shape radiator 21. In one embodiment, the interdigital shape radiator 21 includes the first portion radiator 22 and the second portion radiator 23. The second portion radiator 23 is provided with an interdigital shape, which has a pitch about from 0.4 millimeter to 0.6 millimeter. The feed line 24 is connected to a second end 27 of the first portion radiator 22. In one embodiment, the interdigital shape radiator 21 is configured onto a front side of the dielectric substrate 26 and parallel with the ground plate 20 formed on the rear side of the dielectric substrate 26, wherein the feed line 24 is also parallel with the ground plate 20. Such antenna structure, the feeding line 24 is formed on one side of the dielectric substrate 26 without a ground for providing an ultra wide band characteristic.

The preferred embodiment of the present invention is embodied by using the first portion radiator 22 having a length of 8.0˜12 millimeter and the second portion radiator 23 having a length and a pitch of 20˜30 millimeter and 0.4˜0.6 millimeter respectively and a height of 0.8˜1.2 millimeter. The second portion radiator 23 with an interdigital shape radiates a standing wave mode radiation, which operates in the frequency ranges from 2.0 GHz to 2.8 GHz. The first portion radiator 22 radiates a traveling wave mode radiation which operates in the frequency ranges from 4.5 GHz to 6.5 GHz. In other words, the traveling wave mode radiated by the first portion radiator 22 has a wider band-width than that of the standing wave mode radiated by the second portion radiator 23 with interdigital shape.

In another embodiment, the radiator is co-planar with the ground plate, wherein the feed line is located between two ground plates. Such antenna structure, the feeding component is employed by using a coplanar waveguide (CPW) feeding type. A coplanar waveguide (CPW) feeding line is formed on the side of the dielectric substrate with the antenna pattern. As shown in FIG. 3, the interdigital shape dual band plate antenna includes an interdigital shape radiator 31 having a first portion radiator 32 and a second portion radiator 33, a ground member 34, a coplanar waveguide (CPW) feeding line 35 and a dielectric substrate 36. Similarly, the feed point 37 can be implemented as a coaxial feed. The feed point can also be implemented by placing it at the edge of the interdigital shape radiator 31. The feeding line 35 is connected to a second end 38 of the first portion radiator 32. In other words, the interdigital shape dual band plate antenna is embodied by forming the interdigital shape patch 31 on the dielectric substrate 36 and using the coplanar waveguide (CPW) feeding line 35. Similarly, the preferred embodiment of the present invention is embodied by using the first portion radiator 32 having a length of 8.0˜12 millimeter and the second portion radiator 33 with an interdigital shape having a length and a pitch of 20˜30 millimeter and 0.4˜0.6 millimeter respectively and a height of 0.8˜1.2 millimeter. The second portion radiator 33 with an interdigital radiates a standing wave mode radiation, which operates in the frequency ranges from 2.0 GHz to 2.8 GHz. The first portion radiator 32 radiates a traveling wave mode radiation, which operates in the frequency ranges from 4.5 GHz to 6.5 GHz. In other words, the traveling wave mode radiated by the first portion radiator 32 has a wider band-width than that of the standing wave mode radiated by the second portion radiator 33 with interdigital shape.

Also, the dielectric substrate 36 has a thickness of 0.2˜2 millimeter, and a TTM 4 manufactured by “Rogers” is used as the dielectric substrate 36, where the TTM 4 has a 4.5 of a dielectric constant and 0.002 of loss tangent.

Furthermore, as the interdigital shape and rectangular radiating elements are configured on the substrate, a compact internal antenna can be manufactured. Preferably, the feeding element is arranged vertically to the radiator. However, when a ground condition based on the structure of the terminal equipped with the internal antenna is varied, some physical parameters between the feeding element, radiator and the ground can be varied so that the radiating element radiates the polarized waves of a predetermined band frequency, respectively. Furthermore, the radiating element can be a wire or planar radiating element, and can be variously modified.

The thickness of the above antenna structure (substrate) is about from 0.2 millimeter to 2 millimeter. The pitch of the second portion radiator of the interdigital shape radiator is about from 0.4 millimeter to 0.6 millimeter. The length of the second portion radiator of the interdigital shape radiator is about from 20 millimeter to 30 millimeter, and the width of the second portion radiator is about from 0.2 millimeter to 2.0 millimeter. The length of the first portion radiator of the interdigital shape radiator is about from 8.0 millimeter to 12 millimeter. The line width of the second portion radiator of the interdigital shape radiator is about from 0.2 millimeter to 2.0 millimeter. In one embodiment, an included angle, for example about from 20 to 80 degree, between the first portion radiator and the second portion radiator may be experimentally adjusted until the desired antenna bandwidths and a desired impedance match are obtained. It shall be appreciated that the specific embodiment of the invention has been described herein for purposes of illustration rather than limiting the invention.

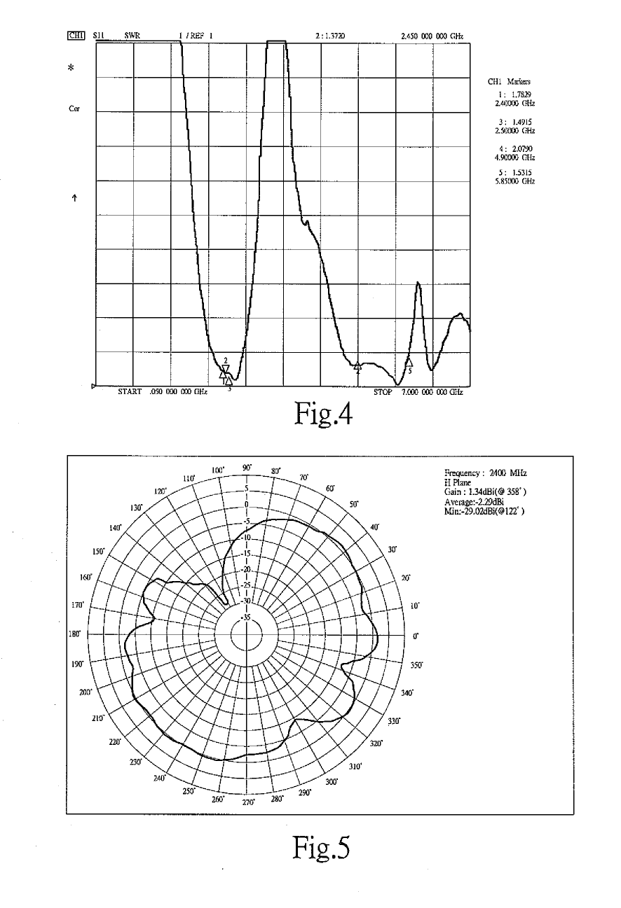

FIG. 4 shows the SWR illustration of the antenna. One of the basic properties to indicate the performance of an antenna includes the standing wave ratio (SWR). The SWR can be derived from the level of reflected and forward waves, is also an indication of how closely or efficiently an antenna's terminal input impedance is matched to the characterized impedance of the transmission line. In 2.4 GHz frequency, the SWR is lower than 2.0. In 4.9˜5.85 GHz frequency, the SWR is lower than 2.0. From point 4 and 5 of the figure, the corresponding frequencies are respectively 4.9 GHz and 5.85 GHz. Thus, the bandwidth of the antenna is wider almost than 300 MHz. The performance of the antenna is pretty good.

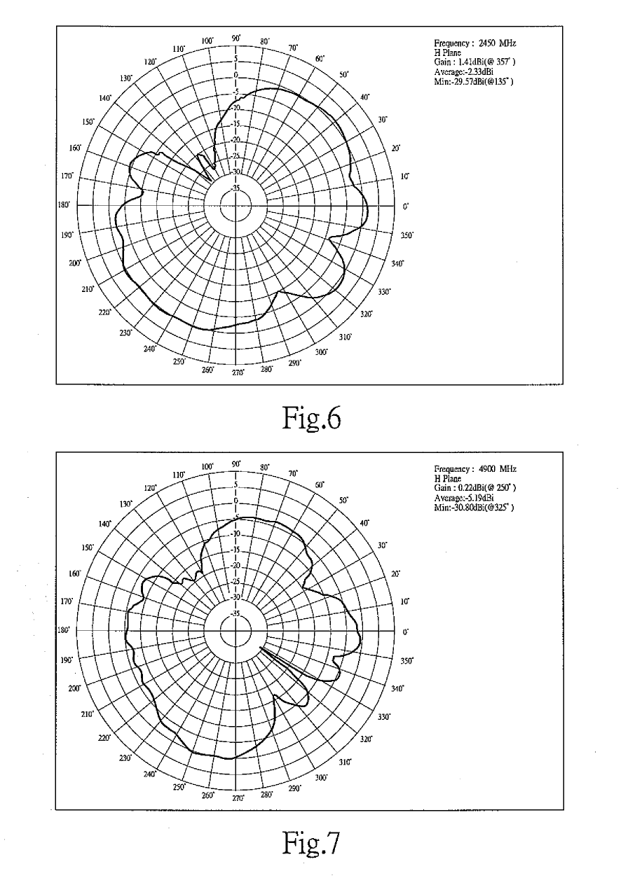

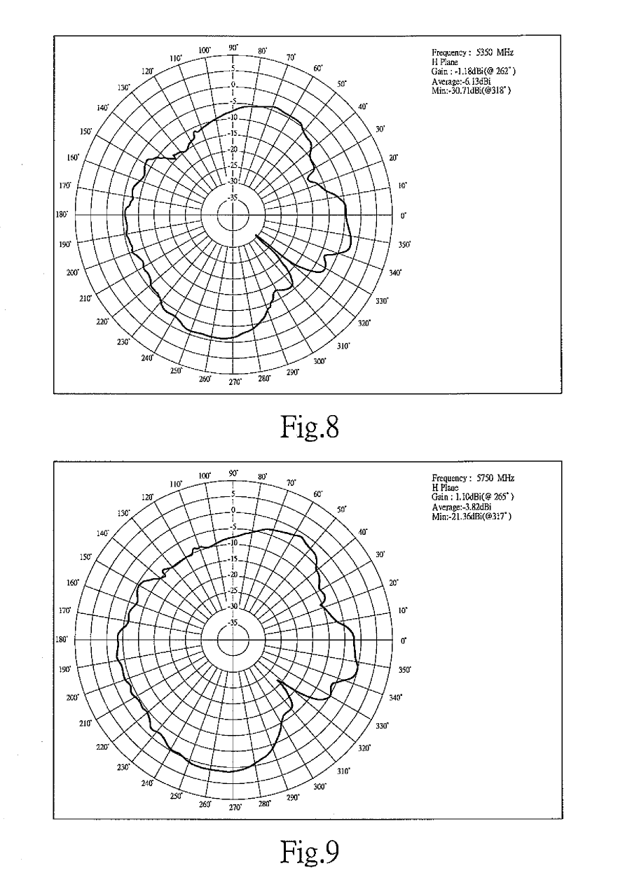

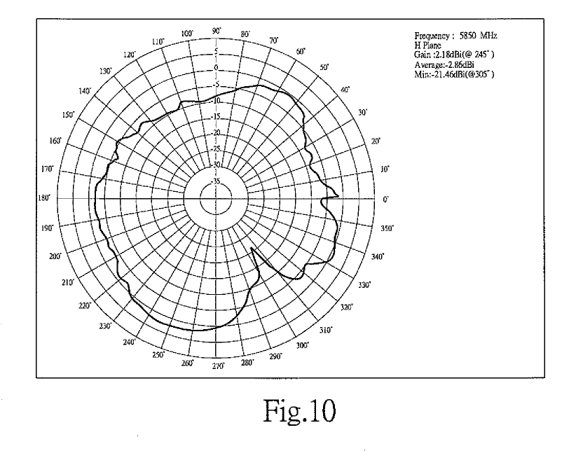

Referring to FIG. 5-10, there are shown radiation pattern of the antenna in accordance with the embodiment of the present invention in a resonant frequency of 2.4, 2.45, 4.9, 5.35, 5.75 and 5.85 GHz, respectively. FIG. 5 shows 2.4 GHz, H plane radiation pattern and the gain is around 1.34 dBi at 358 degree. FIG. 6 shows 2.45 GHz, H plane radiation pattern and the gain is around 1.41 dBi at 357 degree. Similarly, FIG. 7 shows 4.9 GHz, H plane radiation pattern and the gain is around 0.22 dBi at 250 degree. FIG. 8 shows 5.35 GHz, H plane radiation pattern and the gain is around −1.18 dBi at 262 degree. FIG. 9 shows 5.75 GHz, H plane radiation pattern and the gain is around 1.10 dBi at 265 degree. FIG. 10 shows 5.85 GHz, H plane radiation pattern and the gain is around 2.18 dBi at 245 degree. From a measurement result of a radiation pattern of an antenna designed and manufactured in the present invention using the rectangular and the interdigital shape radiating element, it can be seen that a good radiation gain of more than 0 dBi can be obtained. The radiation pattern of the inventive antenna in accordance with the embodiment of the present invention has the considerably improved efficiency of reception.

As above-mentioned, the radiating gain can reach more 2.0 dBi, and therefore multiple antennas disposition have the effects to reduce the interference between space radiating channels and improve the transmission capacity of each one of the channels owing to good performance of the spatial diversity and radiation patterns. Moreover, the planar antenna of the present invention can be applied to a 802.11a/b/g wireless communication system, a smart antenna system and a multiple input multiple output (MIMO) system.

From the foregoing, it shall be appreciated that specific embodiments of the invention have been described herein for purposes of illustration, but that various modifications may be made by those skilled in the art without deviating from the spirit and scope of the invention. Accordingly, the invention is not limited except as by the appended claims.

Having described the invention, the following is claimed:

1. An antenna structure comprising:
a substrate;
a ground member configured on said substrate;
an interdigital shape radiator having a first portion radiator and a second portion radiator configured on said substrate, said second portion radiator being connected to a first end of said first portion radiator; and
a feed line connected to said second end of said first portion radiator of said interdigital shape radiator.

2. The antenna structure of claim 1, wherein said interdigital shape radiator is parallel to said ground member.

3. The antenna structure of claim 1, wherein said interdigital shape radiator is formed on a first surface of said substrate and said ground member is formed on a second surface of said substrate, said first surface being opposite to said second surface.

4. The antenna structure of claim 1, wherein said interdigital shape radiator is co-planar with said ground member.

5. The antenna structure of claim 1, wherein said feeding line is co-planar with said ground member.

6. The antenna structure of claim 1, wherein a feed point of said feeding line is an end of a coplanar waveguide (CPW) feeding type.

7. The antenna structure of claim 1, wherein the thickness of said substrate is about from 0.2 millimeter to 2.0 millimeter.

8. The antenna structure of claim 1, wherein said second portion radiator of said interdigital shape radiator has an interdigital shape.

9. The antenna structure of claim 8, wherein the pitch of said second portion radiator of said interdigital shape radiator is about from 0.4 millimeter to 0.6 millimeter.

10. The antenna structure of claim 8, wherein the length of said second portion radiator is about from 20 millimeter to 30 millimeter.

11. The antenna structure of claim 8, wherein the width of said second portion radiator is about from 0.2 millimeter to 2.0 millimeter.

12. The antenna structure of claim 1, wherein the length of said first portion radiator of said interdigital shape radiator is about from 8 millimeter to 12 millimeter.

13. The antenna structure of claim 1, wherein the width of said first portion radiator of said interdigital shape radiator is about from 0.2 millimeter to 2.0 millimeter.

14. The antenna structure of claim 1, wherein the included angle between said first portion radiator and said second portion radiator is about from 20 to 80 degree.

15. The antenna structure of claim 1, wherein said first portion radiator is used to radiate signal by a traveling wave mode.

16. The antenna structure of claim 1, wherein said second portion radiator is used to radiate signal by a standing wave mode.
